(19) United States
(12) Patent Application Publication
(10) Pub. No.: US 2025/0147253 A1
(43) Pub. Date: May 8, 2025

(54) OPTICAL FIBER CABLE

(71) Applicant: SUMITOMO ELECTRIC INDUSTRIES, LTD., Osaka-shi (JP)

(72) Inventors: Toyoaki KIMURA, Osakai-shi (JP); Fumiaki SATO, Osaka-shi (JP); Yohei SUZUKI, Osaka-shi (JP); Takemasa AKIYAMA, Osaka-shi (JP)

(21) Appl. No.: 18/938,615

(22) Filed: Nov. 6, 2024

(30) Foreign Application Priority Data
Nov. 6, 2023 (JP) 2023-189253

(51) Int. Cl. G02B 6/44

(52) U.S. Cl. CPC G02B 6/4436; G02B 6/443

(57) ABSTRACT

An optical fiber cable includes: a plurality of optical fibers; and a sheath provided around the plurality of optical fibers. The sheath includes an inner layer provided outside the plurality of optical fibers, and an outer layer provided outside the inner layer. A density of a material used for the outer layer is 1.4 g/cm³ or more, and a density of a material used for the inner layer is less than 1.4 g/cm³. An oxygen index of the material used for the outer layer is 36 or more.

### TECHNICAL FIELD

The present disclosure relates to an optical fiber cable. This application is based on and claims priority under 35 USC 119 from Japanese Patent Application No. 2023-189253 filed on Nov. 6, 2023, the contents of which are incorporated herein by reference.

### BACKGROUND

JP2021-060438A discloses an optical fiber cable for pneumatic feeding.

### SUMMARY

The present disclosure provides an optical fiber cable including: a plurality of optical fibers; and a sheath provided around the plurality of optical fibers, in which: the sheath includes an inner layer provided outside the plurality of optical fibers, and an outer layer provided outside the inner layer; a density of a material used for the outer layer is 1.4 g/cm³ or more, and a density of a material used for the inner layer is less than 1.4 g/cm³; and an oxygen index of the material used for the outer layer is 36 or more.

### BRIEF DESCRIPTION OF DRAWINGS

FIG. 1 is a cross-sectional view showing the configuration of an optical fiber cable according to the present embodiment.

FIG. 2 is a plan view showing an example of an optical fiber ribbon accommodated in the optical fiber cable.

FIG. 3 is a cross-sectional view showing the configuration of an optical fiber cable according to a modification.

### DETAILED DESCRIPTION

In recent years, there has been an increasing demand for cable wiring that can be led from outdoors to indoors in order to reduce the number of connection points for optical fiber cables. An outdoor cable does not require much flame retardance, but an indoor cable has a strict standard for the flame retardance, and there is an increasing demand for an optical fiber cable that has the flame retardance required for the indoor cable. However, a material having high flame retardance generally has a low Young's modulus, and as the flame retardance is improved, the strength of the sheath tends to decrease.

An object of the present disclosure is to provide an optical fiber cable having flame retardance while maintaining sufficient strength.

According to the present disclosure, it is possible to provide an optical fiber cable having flame retardance while maintaining sufficient strength.

### DESCRIPTION OF EMBODIMENTS OF PRESENT DISCLOSURE

First, an embodiment of the present disclosure will be listed and described.
(1) An optical fiber cable according to an aspect of the present disclosure includes: a plurality of optical fibers; and a sheath provided around the plurality of optical fibers, in which: the sheath includes an inner layer provided outside the plurality of optical fibers, and an outer layer provided outside the inner layer; a density of a material used for the outer layer is 1.4 g/cm³ or more, and a density of a material used for the inner layer is less than 1.4 g/cm³; and an oxygen index of the material used for the outer layer is 36 or more.

According to such a configuration, the outer layer is formed of a material having a density of 1.4 g/cm³ or more and an oxygen index of 36 or more, and thus has high flame retardance. On the other hand, since the inner layer is formed of a material having a density of less than 1.4 g/cm³, the entire cable has sufficient strength. Accordingly, an optical fiber cable having flame retardance while maintaining sufficient strength can be provided.
(2) In the optical fiber cable according to the above (1), an average value of an arithmetic mean roughness Ra of the outer layer may be 0.8 μm or less, and an average value of a maximum height roughness Rz of the outer layer may be 6.0 μm or less.

According to such a configuration, since the outer layer has high surface smoothness, it is possible to reduce friction between the sheath of the optical fiber cable and the duct when, for example, the optical fiber cable is pneumatically fed in the duct as a cable laying operation.
(3) The optical fiber cable according to the above (1) or (2), further includes: a plurality of tension members provided in the inner layer, in which the material used for the inner layer has a storage modulus of 800 MPa or more at 23° C.

According to such a configuration, since the inner layer in which the tension member is provided has high strength, it is possible to prevent the tension member from breaking when, for example, the extra length of the optical fiber cable is bundled as a cable laying operation.
(4) In the optical fiber cable according to the above (3), a thickness of the inner layer is larger than a diameter of each of the plurality of tension members by 0.1 mm or more, and is equal to or less than a half of a thickness of the sheath.

According to this configuration, the tension member can be embedded in the inner layer while achieving both the strength and the flame retardance.

### DETAILS OF EMBODIMENTS OF PRESENT DISCLOSURE

A specific example of a slotless optical fiber cable according to an embodiment of the present disclosure will be described below with reference to the drawings.

The present disclosure is not limited to these exemplifications, but is indicated by the scope of claims, and is intended to include all modifications within a scope and meaning equivalent to the scope of claims.

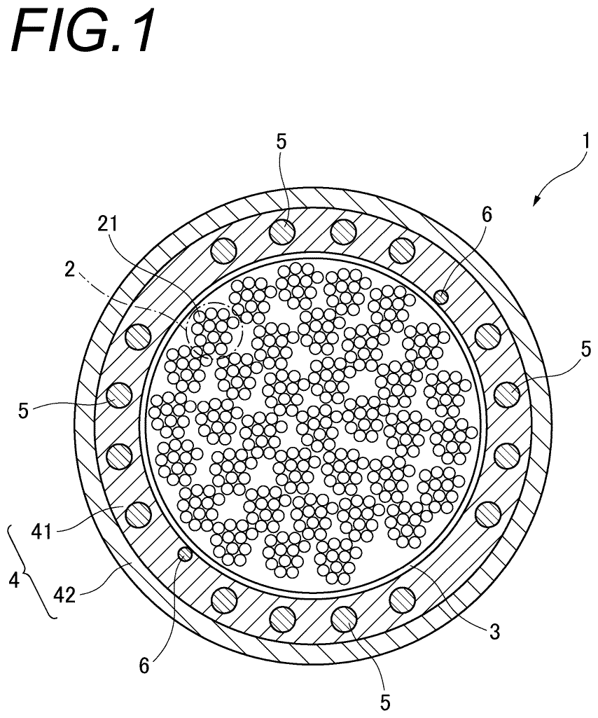

FIG. 1 shows the configuration of an optical fiber cable 1 according to the present embodiment. FIG. 1 shows a cross section perpendicular to the length direction of an optical fiber cable 1. In this example, the optical fiber cable 1 is a slotless optical fiber cable. The optical fiber cable 1 is used as, for example, an optical fiber cable for pneumatic feeding laid in a microduct for pneumatic feeding.

As shown in FIG. 1, the optical fiber cable 1 includes a plurality of optical fiber ribbons 2, a water absorption tape 3, a sheath 4, a plurality of tension members 5, and a ripping cord 6.

The optical fiber ribbon 2 is formed by connecting a plurality of optical fibers 21 arranged in parallel. The optical fiber 21 is formed by, for example, a glass fiber including a core and a cladding, and a coating layer that coats the outer periphery of the glass fiber.

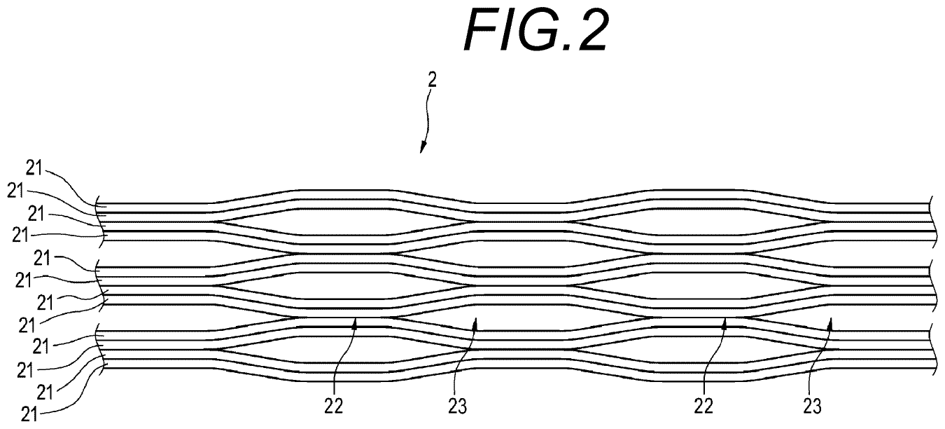

FIG. 2 shows an example of the intermittent connection type optical fiber ribbon 2. FIG. 2 shows a state in which the plurality of optical fibers 21 are opened in the arrangement direction.

As shown in FIG. 2, in a state in which the plurality of optical fibers 21 are arranged in parallel, a connecting portion 22 in which adjacent optical fibers 21 are connected and a non-connecting portion 23 in which adjacent optical fibers 21 are not connected are intermittently provided in the longitudinal direction. In this example, twelve optical fibers 21 are intermittently connected every two fibers. That is, the units in which two optical fibers 21 are integrated are intermittently connected by the connecting portion 22 and the non-connecting portion 23. In the connecting portion 22, for example, the optical fibers 21 are connected to each other by applying a connecting resin between the optical fibers 21. All adjacent optical fibers 21 (every single fiber) may be intermittently connected instead of every two fibers.

The optical fiber ribbon 2 is accommodated in the optical fiber cable 1 in a rolled state. Alternatively, the plurality of optical fiber ribbons 2 may be accommodated in the optical fiber cable 1 in a twisted state. Further, the plurality of optical fiber ribbons 2 bundled together or twisted together may be bundled using a bundle material or the like.

The water absorption tape 3 covers the periphery of the optical fiber ribbon 2. Specifically, the water absorption tape 3 is longitudinally or spirally wrapped around the whole of the plurality of optical fiber ribbons 2, for example. The water absorption tape 3 is made by performing water absorption processing by applying water absorption powder to a base cloth made of polyester, for example.

The sheath 4 covers the periphery of the water absorption tape 3. The sheath 4 is formed by, for example, extrusion-molding a resin on the plurality of optical fiber ribbons 2 around which the water absorption tape 3 is wrapped.

The sheath 4 includes an inner layer 41 and an outer layer 42. The inner layer 41 covers the periphery of the water absorption tape 3 provided outside the plurality of optical fibers 21. The material used for the inner layer 41 has a density of less than 1.4 g/cm³. The material is not particularly limited as long as the material has the density of less than 1.4 g/cm³, but as the material used for the inner layer 41, for example, polyethylene or the like is used.

The outer layer 42 is provided outside the inner layer 41. The material used for the outer layer 42 has a density of 1.4 g/cm³ or more. The material is not particularly limited as long as the material has a density of 1.4 g/cm³ or more, but as the material used for the outer layer 42, for example, a flame-retardant polyolefin obtained by blending a substance that improves the flame retardance with a high-density polyethylene as a base material is used.

The tension members 5 are provided inside the sheath 4. Specifically, the tension members 5 are embedded in the inner layer 41 of the sheath 4 along the longitudinal direction of the optical fiber cable 1. The tension members 5 are made of fiber reinforced plastic (FRP) such as aramid FRP, glass FRP, or carbon FRP. Alternatively, the tension members 5 may be formed of metal. In this example, four tension members 5 close to each other are set as one group, and four groups are arranged at equal intervals. The number and arrangement of the tension members 5 are not limited to those in FIG. 1.

The thickness of the inner layer 41 is preferably equal to or more than the diameter of the tension member 5+0.1 mm and equal to or less than a half of the thickness of the sheath 4. For example, the thickness of the sheath 4 is 1.8 mm, the diameter of the tension member 5 is 0.5 mm, the thickness of the inner layer 41 is 0.6 mm, and the thickness of the outer layer 42 is 1.2 mm.

The ripping cord 6 is provided inside the sheath 4. Specifically, the ripping cord 6 is embedded in the inner layer 41 of the sheath 4 along the longitudinal direction of the optical fiber cable 1. The operator can tear the sheath 4 in the longitudinal direction by pulling the ripping cord 6 out of the sheath 4 and take out the optical fiber ribbon 2. The ripping cord 6 is made of, for example, a plastic material (for example, polyester) resistant to tension. In this example, two ripping cords 6 face each other. The number and arrangement of the ripping cords 6 are not limited to those in FIG. 1.

Here, there is an increasing demand for cable wiring that can be led from outdoors to indoors in order to reduce the number of connection points for optical fiber cables, and there is an increasing demand for an optical fiber cable that has the flame retardance required for the indoor cable. When imparting the flame retardance to the optical fiber cable, it is conceivable, for example, to form a sheath with a material having the flame retardance. However, a flame-retardant material generally used for a sheath has a lower tensile strength and Young's modulus than a non-flame-retardant material, and in particular, softens at a higher temperature, which 15 may result in deterioration of the handling properties (the straightness, the low friction, the cable extra length (bundling), and the like) of the cable during pneumatic feeding, or may lead to kink in the cable itself.

According to the optical fiber cable 1 in the present embodiment, the material density of the outer layer 42 is 1.4 g/cm³ or more, and the outer layer 42 has high flame retardance because the outer layer 42 contains a substance that improves the flame retardance. Since the material used for the outer layer 42 has an oxygen index of 36 or more, the flame retardance of the outer layer 42 can be improved. Here, the oxygen index is the minimum oxygen concentration required for continuing combustion, as specified in JIS K7201.

On the other hand, the material density of the inner layer 41 is less than 1.4 g/cm³. However, since the flame retardance of the inner layer 41 is reduced, the material strength of the inner layer 41 is larger than that of the outer layer 42. That is, in the optical fiber cable 1, the inner layer 41 close to the inside of the cable is made of a material giving priority to the strength over the flame retardance, and the outer layer 42 exposed to the outside is made of a material giving priority to the flame retardance. Accordingly, it is possible to provide the optical fiber cable 1 having the flame retardance while maintaining sufficient strength.

In the optical fiber cable 1, the material used for the inner layer 41 may have a storage modulus of 800 MPa or more at 23° C. Accordingly, since the strength of the inner layer 41 can be increased, for example, when the extra length of the optical fiber cable 1 is bundled, the tension member 5 provided in the inner layer 41 can be prevented from breaking. Here, the storage modulus is a physical property value that can be measured by dynamic viscoelasticity measurement (DMS).

In the optical fiber cable 1, the average value of an arithmetic mean roughness Ra of the outer layer 42 may be 0.8 μm or less, and the average value of a maximum height roughness Rz of the outer layer 42 may be 6.0 μm or less. According to such a configuration, since the outer layer 42 has high surface smoothness, it is possible to reduce friction between the sheath of the optical fiber cable 1 and the duct when, for example, the optical fiber cable 1 is pneumatically fed in the duct as a cable laying operation.

Here, the arithmetic mean roughness Ra and the maximum height roughness Rz are defined in JIS B 0601:2013.

The method for obtaining the average value of the arithmetic mean roughness Ra and the maximum height roughness Rz is not particularly limited. For example, in any cross section perpendicular to the longitudinal direction of the optical fiber cable 1, four measurement points are set at equal intervals along the circumferential direction of the outer periphery. The arithmetic mean roughness Ra and the maximum height roughness Rz are measured at each measurement point along the longitudinal direction of the optical fiber cable 1. The average value of the measurement values at the four measurement points is defined as the average value of the arithmetic mean roughness Ra and the maximum height roughness Rz.

### Example 1

The flame retardance and the kink resistance of the sheath 4 obtained by combining the inner layer and the outer layer that have different material densities, oxygen indexes, and storage moduli were evaluated. The evaluation results are shown in Table 1. Regarding the flame retardance, a sample was evaluated as A (passed) when passed the riser combustion test (applied safety standard UL1666), and was evaluated as B (failed) when failed the riser combustion test. Regarding the kink resistance, a sample was evaluated as A (passed) when the optical fiber cable 1 did not kink (not twist) even after being left at 70° C. for 5 minutes in a state in which the optical fiber cable 1 was formed into a loop having a diameter of 150 mm, and was evaluated as B (failed) when the optical fiber cable 1 did kink.

TABLE 1

| | Sample 1 | Sample 2 | Sample 3 |
|---|---|---|---|
| Density (g/cm³) | Inner layer < 1.40 | 0.92 ≤ inner layer < 1.40 | Inner layer ≥ 1.40 |
| | Outer layer ≥ 1.40 | 0.92 ≤ outer layer < 1.40 | Outer layer ≥ 1.40 |
| Oxygen index | Inner layer < 36 | Inner layer < 25 | Inner layer ≥ 36 |
| | Outer layer ≥ 36 | Outer layer < 36 | Outer layer ≥ 36 |
| Storage modulus | 1200 ≥ inner layer ≥ 800 | Inner layer ≥ 1200 | Inner layer < 800 |
| (MPa) (23° C.) | Outer layer < 800 | Outer layer < 800 | Outer layer < 800 |
| Flame retardance | A | B | A |
| Kink resistance | A | A | B |

Based on Table 1, a sample 1 was good in both the flame retardance and the kink resistance. A sample 2 was good in the kink resistance. A sample 3 was good in only the flame retardance.

That is, based on the evaluation results of the sample 1 and the sample 3, it was found that the flame retardance was good when the material density of the outer layer was 1.4 g/cm³ or more and the oxygen index was 36 or more. Based on the evaluation results of the sample 1 and the sample 2, it was found that the kink resistance was good when the material density of the inner layer was less than 1.4 g/cm³ and the storage modulus of the material used for the inner layer at 23° C. was 800 MPa or more.

### Example 2

The surface roughness of the sheath was evaluated. The evaluation results are shown in Table 2. Specifically, the average value of the arithmetic mean roughness Ra and the maximum height roughness Rz of each sheath was measured using a flame-retardant sheath and a non-flame-retardant sheath formed of one layer. As the flame-retardant sheath, a sheath having an oxygen index of 36 or more and a material density of less than 1.4 g/cm³ and a sheath having an oxygen index of 36 or more and a material density of 1.4 g/cm³ or more were used. As the non-flame-retardant sheath, a sheath having an oxygen index of less than 36 and a material density of 1.4 g/cm³ or less, like the outer layer used in the sample 2, was used.

As described above, by setting four measurement points at equal intervals along the circumferential direction of the outer periphery on any cross section perpendicular to the longitudinal direction of the optical fiber cable 1, the arithmetic mean roughness Ra and the maximum height roughness Rz were measured along the longitudinal direction of the optical fiber cable 1 at the measurement points. For the arithmetic mean roughness Ra and the maximum height roughness Rz, the average value of the measured values at the four measurement points was obtained.

TABLE 2

| | Sample 4 | Sample 5 | Sample 6 |
|---|---|---|---|
| | Flame-retardant sheath: | Flame-retardant sheath: | Non-flame-retardant sheath: |
| | density less than 1.4 | density 1.4 or more | density 1.4 or less |
| First point | Ra: 0.34 μm | Ra: 0.31 μm | Ra: 1.15 μm |
| | Rz: 2.1 μm | Rz: 2.1 μm | Rz: 6.8 μm |
| Second point | Ra: 0.35 μm | Ra: 0.31 μm | Ra: 0.78 μm |
| | Rz: 2.3 μm | Rz: 2.1 μm | Rz: 10.8 μm |
| Third point | Ra: 0.35 μm | Ra: 0.41 μm | Ra: 1.44 μm |
| | Rz: 2.5 μm | Rz: 2.4 μm | Rz: 7.4 μm |
| Fourth point | Ra: 0.58 μm | Ra: 0.51 μm | Ra: 1.36 μm |
| | Rz: 3.6 μm | Rz: 4.8 μm | Rz: 7.3 μm |
| Average from | Ra: 0.41 μm | Ra: 0.39 μm | Ra: 1.18 μm |
| first point to | Rz: 2.6 μm | Rz: 2.9 μm | Rz: 8.1 μm |
| fourth point | | | |

Based on Table 2, in a sample 4, the average of the arithmetic mean roughness Ra was 0.41 μm, the average of the maximum height roughness Rz was 2.6 μm, and the surface smoothness was good. Whether the surface smoothness was good was determined based on whether the optical fiber cable 1 was pneumatically fed to a reference distance when pneumatic feeding was executed under the same conditions. In a sample 5, the average of the arithmetic mean roughness Ra was 0.39 μm, the average of the maximum height roughness Rz was 2.9 μm, and the surface smoothness was good. In a sample 6, the average of the arithmetic mean roughness Ra was 1.18 μm, the average of the maximum height roughness Rz was 8.1 μm, and good surface smoothness was not obtained. That is, it was found that the surface smoothness was good in the sheath having the flame retardance, an average value of the arithmetic mean roughness Ra of 0.8 μm or less, and an average value of the maximum height roughness Rz of 6.0 μm or less.

Although the present disclosure has been described in detail with reference to the specific embodiment, it is apparent to those skilled in the art that various changes and modifications can be made without departing from the spirit and scope of the present disclosure. In addition, the number, positions, shapes, and the like of the constituent members described above are not limited to those in the above embodiment, and can be changed to the numbers, positions, shapes, and the like suitable for carrying out the present disclosure.

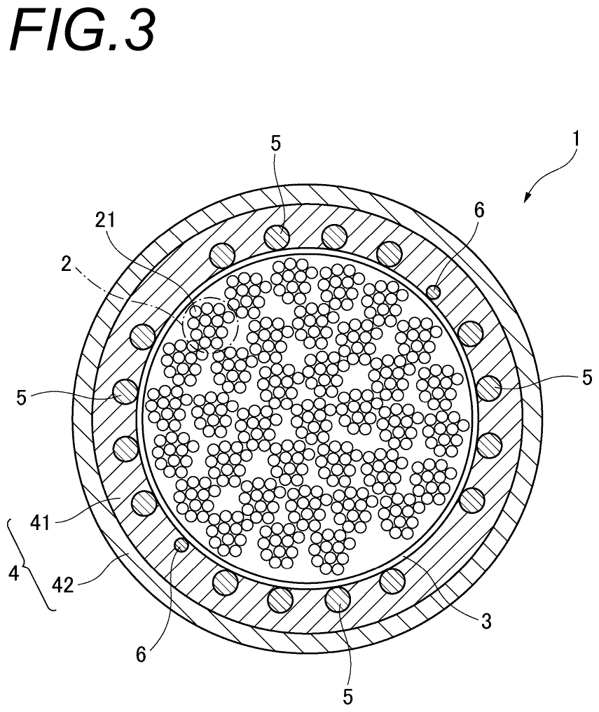

In the above embodiment, the tension member 5 is completely embedded in the inner layer 41 of the sheath 4. However, the tension member 5 may be provided such that a part thereof is exposed from the inner layer 41 of the sheath 4. FIG. 3 shows the configuration of the slotless optical fiber cable 1 in which a part of the tension member 5 is exposed from the inner layer 41 of the sheath 4 toward the water absorption tape 3. According to such a configuration, the thickness of the inner layer 41 can be reduced, and as a result, an increase in the outer diameter of the cable can be prevented.

In the above embodiment, the plurality of optical fibers 21 are provided in the optical fiber cable 1 in the form of the optical fiber ribbon 2. However, for example, the plurality of optical fibers 21 may be arranged in the optical fiber cable 1 in a single fiber state, bundled together, or twisted together. In this case, the plurality of single-fiber optical fibers 21 bundled together or twisted together may be bundled using a bundle material or the like. Alternatively, the plurality of optical fibers 21 may be provided in the optical fiber cable 1 in a state in which a part thereof is in the form of the optical fiber ribbon and the rest is a single fiber.

In the above embodiment, the optical fiber ribbon 2 is formed by twelve optical fibers 21. However, the optical fiber ribbon 2 may be formed by, for example, 16 or 24 optical fibers 21.

In the above embodiment, the slotless optical fiber cable is described as an example of the optical fiber cable 1 according to the present disclosure. Alternatively, the optical fiber cable according to the present disclosure may be a slot optical fiber cable. The internal structure of the optical fiber cable may be any structure such as a structure in which the optical fiber is bundled with a bundle thread, a structure in which the optical fiber is put in a loose tube, and a structure in which the optical fiber is wrapped with a film.

What is claimed is:

1. An optical fiber cable comprising:
a plurality of optical fibers; and
a sheath provided around the plurality of optical fibers,
wherein the sheath comprises an inner layer provided outside the plurality of optical fibers, and an outer layer provided outside the inner layer,
wherein a density of a material used for the outer layer is 1.4 g/cm³ or more, and a density of a material used for the inner layer is less than 1.4 g/cm³, and
wherein an oxygen index of the material used for the outer layer is 36 or more.

2. The optical fiber cable according to claim 1,
wherein an average value of an arithmetic mean roughness Ra of the outer layer is 0.8 μm or less, and an average value of a maximum height roughness Rz of the outer layer is 6.0 μm or less.

3. The optical fiber cable according to claim 1, further comprising:
a plurality of tension members provided in the inner layer,
wherein the material used for the inner layer has a storage modulus of 800 MPa or more at 23° C.

4. The optical fiber cable according to claim 3,
wherein a thickness of the inner layer is larger than a diameter of each of the plurality of tension members by 0.1 mm or more, and is equal to or less than a half of a thickness of the sheath.
